(19) United States
(12) Patent Application Publication
(10) Pub. No.: US 2026/0213226 A1
(43) Pub. Date: Jul. 23, 2026

(54) CATALYST FOR A FUEL CELL AND A METHOD OF PREPARING THE SAME

(71) Applicants: HYUNDAI MOTOR COMPANY, Seoul (KR); KIA CORPORATION, Seoul (KR); KOREA UNIVERSITY RESEARCH AND BUSINESS FOUNDATION, Seoul (KR)

(72) Inventors: Daeyong Son, Hwaseong-si (KR); Jongkil Oh, Hwaseong-si (KR); Jemin Kim, Hwaseong-si (KR); KwangYeol Lee, Seoul (KR); YeJi Park, Seoul (KR); DoYeop Kim, Gyeongju-si (KR); MinSu Kim, Seoul (KR); ByeongYoon Kim, Seoul (KR)

(73) Assignees: HYUNDAI MOTOR COMPANY, Seoul (KR); KIA CORPORATION, Seoul (KR); KOREA UNIVERSITY RESEARCH AND BUSINESS FOUNDATION, Seoul (KR)

(21) Appl. No.: 19/182,178

(22) Filed: Apr. 17, 2025

(30) Foreign Application Priority Data
Jan. 22, 2025 (KR) 10-2025-0009300

(51) Int. Cl. H01M 4/92; H01M 4/88

(52) U.S. Cl. CPC H01M 4/926; H01M 4/8882

(57) ABSTRACT

A catalyst for a fuel cell includes a carrier and intermetallic compound particles supported on the carrier, wherein the intermetallic compound particles include a noble metal and a transition metal. A peak representing a superlattice is present in a spectrum obtained by X-ray diffraction analysis, and a decrease in a position of a noble metal binding energy peak of the catalyst including the intermetallic compound particles is 0.1 eV or more, based on a noble metal binding energy peak of a catalyst including irregular alloy particles of the same noble metal-transition metal components in the noble metal binding energy-intensity spectrum obtained by X-ray photoelectron spectroscopy.

### CROSS-REFERENCE TO RELATED APPLICATION

This application claims, under 35 U.S.C. § 119(a), the benefit of and priority to Korean Patent Application No. 10-2025-0009300, filed on Jan. 22, 2025, the entire contents of which are incorporated herein by reference.

### BACKGROUND

### Technical Field

The present disclosure relates to a catalyst for a fuel cell and a method of preparing the same.

### Background Art

Polymer electrolyte membrane fuel cells (PEMFCs) are expected to have great potential for application in a variety of fields, including power supplies for portable electronic devices, household use, transportation, and power generation. However, the high price of platinum catalysts used to promote oxygen reduction reaction (ORR) that occurs at the cathode (reduction electrode) of fuel cells is a major obstacle to commercialization of fuel cells.

Platinum-transition metal alloy catalysts have been developed to reduce the use of expensive platinum and to increase catalytic activity, but have a disadvantage in that the initial high catalytic activity cannot be maintained over long periods of fuel cell operation due to rapid dissolution of transition metals under fuel cell operating conditions.

To solve these problems, thorough research is ongoing recently on nano-catalysts in which platinum and a transition metal are regularly arranged through a heat treatment process in which a platinum-transition metal alloy is heated to a high temperature of 1,000° C. However, there is a problem in that agglomeration of metal particles during the high-temperature heat treatment process reduces the surface area of the catalyst and affects the performance of the fuel cell.

### SUMMARY OF THE DISCLOSURE

The present disclosure has been made keeping in mind the problems encountered in the related art, and an object of the present disclosure is to provide a catalyst for a fuel cell, which prevents agglomeration and includes intermetallic compound particles having a small size.

Another object of the present disclosure is to provide a catalyst for a fuel cell, in which some electrons at a transition metal position move to a noble metal position compared to an irregular alloy catalyst, thus increasing the electron density at the noble metal position, and the noble metal binding energy peak position changes in the XPS spectrum, thus improving oxygen reduction reaction (ORR). Another object of the present disclosure is a fuel cell member and a fuel cell including the catalyst described above.

Still another object of the present disclosure is to provide a method of preparing a catalyst for a fuel cell that is easy to mass-produce and economical because the process is simplified.

The objects of the present disclosure are not limited to the foregoing. The objects of the present disclosure are able to be clearly understood through the following description and to be realized by the means described in the claims and combinations thereof.

In order to accomplish the above objects, an aspect of the present disclosure provides a catalyst for a fuel cell including a carrier and intermetallic compound particles supported on the carrier, in which the intermetallic compound particles include a noble metal and a transition metal. Further, a peak representing a superlattice is present in the spectrum obtained by X-ray diffraction analysis, and a decrease in a position of a noble metal binding energy peak of the catalyst including the intermetallic compound particles is 0.1 eV or more, based on a noble metal binding energy peak of a catalyst including irregular alloy particles of identical noble metal-transition metal components in the noble metal binding energy-intensity spectrum obtained by X-ray photoelectron spectroscopy.

Another aspect of the present disclosure provides a method of preparing a catalyst for a fuel cell, including obtaining a first mixture by mixing a carrier with a binary metal precursor including a noble metal precursor and a first transition metal precursor, where the method further includes obtaining the catalyst described above by heat-treating the mixture in a reducing atmosphere, or obtaining a second mixture by heat-treating the first mixture in a reducing atmosphere and adding a second transition metal precursor, and obtaining the catalyst described above by heat-treating the second mixture containing the second transition metal precursor in a reducing atmosphere The second transition metal precursor does not include a nitrate, and the heat treatment temperature is in a range of 400° C. to 800° C.

### BRIEF DESCRIPTION OF THE DRAWINGS

The above and other features of the present disclosure are described below in detail with reference to certain embodiments thereof illustrated in the accompanying drawings which are given hereinbelow by way of illustration only, and thus are not limitative of the present disclosure.

FIG. 1A and FIG. 1B show transmission electron microscopy (TEM) and X-ray diffraction (XRD) results of Example 1, respectively.

FIG. 2A and FIG. 2B show TEM results of Example 2 and Example 3, respectively.

FIG. 3A and FIG. 3B show XRD results of Example 2 and Example 3, respectively.

FIG. 4A and FIG. 4B show TEM and XRD results of Example 4, respectively.

FIG. 5A and FIG. 5B show TEM and XRD results of Example 5, respectively.

FIG. 6A and FIG. 6B show TEM and XRD results of Example 6, respectively.

FIG. 7A and FIG. 7B show TEM and XRD results of Comparative Example 1, respectively.

FIG. 8A and FIG. 8B show TEM and XRD results of Comparative Example 2, respectively.

FIG. 9A, FIG. 9B, and FIG. 9C show high-resolution scanning transmission electron microscopy results of Example 4 and a fast Fourier transform pattern along the [100] zone axis, respectively.

FIG. 10 shows high-angle annular dark-field scanning transmission electron microscopy results of Example 4 and energy dispersive X-ray spectroscopy (EDS) mapping images.

FIG. 11 shows binding energy results of nitrogen (1s) of Example 4 according to X-ray photoelectron spectroscopy.

FIG. 12A and FIG. 12B show high-resolution scanning transmission electron microscopy results of Example 6 and a fast Fourier transform pattern along the [110] zone axis, respectively.

FIG. 13A and FIG. 13B show EDS mapping images of Example 6 and line profile analysis results, respectively.

FIG. 14A, FIG. 14B and FIG. 14C show electron energy loss spectrum (EELS) results of Example 6.

FIG. 15A shows high-angle annular dark-field scanning transmission electron microscopy results of Example 6, EDS mapping images, and FIG. 15B shows line profile analysis results, respectively.

FIG. 16 shows binding energy results of nitrogen (1s) of Example 6 according to X-ray photoelectron spectroscopy.

FIGS. 17 and 18 show TEM results of effects of N doping and Ni introduction on the size of intermetallic compound particles in Examples 1, 4, 5, and 6 respectively.

FIG. 19A, FIG. 19B, and FIG. 19C show high-resolution scanning transmission electron microscopy results of Example 6 and EDS mapping results, respectively

FIG. 20 shows EDS line profile analysis results of Example 6.

FIG. 21 shows high-resolution scanning transmission electron microscopy (HRSTEM) results of Comparative Example 3.

FIG. 22 is a graph showing results of linear sweep voltammetry (LSV) measured with the three-electrode system for a Pt/C catalyst and catalysts of Example 4, Example 6, and Comparative Example 3.

FIG. 23A, FIG. 23B, and FIG. 23C show the oxygen reduction reaction polarization curve, half-wave potential, and activity change, respectively, of each of Pt/C and the catalysts of Comparative Example 3, Example 4, and Example 6 before and after 30k cycles of accelerated durability testing.

FIG. 24A, FIG. 24B, and FIG. 24C show transmission electron microscopy results of the catalysts of Comparative Example 3, Example 4, and Example 6 after 30k cycles of accelerated durability testing respectively.

FIG. 25 shows X-ray diffraction analysis spectra of the catalysts of Example 4 and Example 6 after 30k cycles of accelerated durability testing.

FIG. 26A, FIG. 26B, and FIG. 26C show the oxygen reduction reaction polarization curve, half-wave potential, and activity change, respectively, of Example 6 before and after 50k, 100k, and 150k cycles of accelerated durability testing, in which the number of cycles of accelerated durability testing is increased.

FIG. 27A, FIG. 27B, and FIG. 27C show transmission electron microscopy results of Example 6 after 50k, 100k, and 150k cycles of accelerated durability testing respectively.

FIG. 28 shows X-ray diffraction analysis spectrum of Example 6 after 150k cycles of accelerated durability testing.

FIG. 29A, FIG. 29B, and FIG. 29C show XPS spectra of the binding energy peaks of Pt⁰ and Pt²⁺, Co⁰ and Co²⁺, Ni⁰ and Ni²⁺ of Comparative Example 3, Example 4, and Example 6 respectively.

FIG. 30 is a graph showing a change in binding energy for each element in Comparative Example 3, Example 4, and Example 6.

### DETAILED DESCRIPTION

The above and other objects, features and advantages of the present disclosure are more clearly understood from the following embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those having ordinary skill in the art.

Throughout the drawings, the same reference numerals will refer to the same or like elements. For the sake of clarity of the present disclosure, the dimensions of structures are depicted as being larger than the actual sizes thereof. It is understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It is further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it is understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

### Catalyst for a Fuel Cell

A catalyst for a fuel cell according to an aspect of the present disclosure includes a carrier and intermetallic compound particles supported on the carrier, where the intermetallic compound particles include a noble metal and a transition metal, where a peak representing a superlattice is present in the spectrum obtained by X-ray diffraction analysis, and where a decrease in the position of the noble metal binding energy peak of the catalyst including the intermetallic compound particles is 0.1 eV or more, based on the noble metal binding energy peak of a catalyst including irregular alloy particles of the same noble metal-transition metal components in the noble metal binding energy-intensity spectrum obtained by X-ray photoelectron spectroscopy.

A superlattice is a structure formed by different elements being regularly arranged in a certain order within a unit lattice, and may be confirmed by a specific peak in the spectrum from X-ray diffraction analysis and results from fast Fourier transform analysis. The intermetallic compound particles of the catalyst for a fuel cell may include such a superlattice structure, and also a shift or decrease in the position of the noble metal binding energy peak of the catalyst including the intermetallic compound particles determined by X-ray photoelectron spectroscopy, based on the noble metal binding energy peak of a catalyst including irregular alloy particles determined by X-ray photoelectron spectroscopy. This structure may be derived from the formation of unique intermetallic compound particles according to a method of preparing a catalyst for a fuel cell described below.

The irregular alloy may be an alloy in which a noble metal and a transition metal are irregularly arranged, may be an alloy in which an XRD peak related to an intermetallic compound does not appear, and may correspond to alloy particles of a catalyst prepared according to Comparative Example 3 below.

The noble metal may include platinum, palladium, iridium, ruthenium, rhodium, osmium, gold, silver, or any combinations thereof, and an example thereof may include platinum.

The transition metal may include cobalt, iron, copper, nickel, or any combinations thereof, and one or two thereof may be used.

The intermetallic compound particles may include a structure in which the noble metal and the transition metal are alternately arranged in a specific direction.

For example, as shown in the Test Example below, an order of noble metal-transition metal-noble metal-transition metal may appear in a fast Fourier transform pattern along a specific zone axis, in which the transition metal may include one or two of the examples listed above.

The intermetallic compound particles may include platinum-cobalt, platinum-iron, platinum-copper, platinum-cobalt-nickel, or any combinations thereof. When the ternary system of platinum-cobalt-nickel is included, further improved oxygen reduction reaction (ORR) characteristics may be exhibited.

When platinum is included as a noble metal of the intermetallic compound particles, a decrease in the position of the platinum (4f_{7/2}) binding energy peak of the catalyst including the intermetallic compound particles determined by X-ray photoelectron spectroscopy may be 0.1 eV or more, 0.2 eV or more, or 0.25 eV or more, and 0.5 eV or less, or 0.42 eV or less, based on the platinum (4f_{7/2}) binding energy peak of a catalyst including irregular alloy particles of the same component determined by X-ray photoelectron spectroscopy.

In addition, when cobalt is included as a transition metal of the intermetallic compound particles, an increase in the position of the cobalt (2p_{3/2}) binding energy peak of the catalyst including the intermetallic compound particles determined by X-ray photoelectron spectroscopy may be 0.1 eV or more, or 0.2 eV or more, and 0.5 eV or less, based on the cobalt (2p_{3/2}) binding energy peak of a catalyst including irregular alloy particles of the same component determined by X-ray photoelectron spectroscopy.

In addition, when nickel is included as a transition metal of the intermetallic compound particles, an increase in the position of the nickel (2p_{3/2}) binding energy peak of the catalyst including the intermetallic compound particles determined by X-ray photoelectron spectroscopy may be 0.05 eV or more, or 0.1 eV or more, and 0.4 eV or less, based on the nickel (2p_{3/2}) binding energy peak of a catalyst including irregular alloy particles of the same component determined by X-ray photoelectron spectroscopy.

The change in metal binding energy peak determined by X-ray photoelectron spectroscopy may be interpreted as an increase in the electron density at the platinum position due to movement of electrons from the transition metal position to the noble metal platinum position. Accordingly, agglomeration between particles may be minimized and good oxidation reduction reaction (ORR) characteristics may be exhibited.

In the spectrum obtained by X-ray diffraction analysis of the catalyst for a fuel cell, the peaks representing the superlattice of the intermetallic compound particles including platinum-cobalt may be present at 32-34° and 53-55°. The peak representing the superlattice of the intermetallic compound particles including platinum-iron may be present at 32-34°. The peak representing the superlattice of the intermetallic compound particles including platinum-copper may be present at 19-21°. The peaks representing the superlattice of the intermetallic compound particles including platinum-cobalt-nickel may be present at 32-34° and 53-55°.

The carrier may include carbon, and examples thereof include carbon black, Ketjen black, graphite, carbon nanotubes, carbon nanofiber, and the like.

The catalyst for a fuel cell may further include a dopant element containing nitrogen. The catalyst may be doped by mixing a precursor including a nitrate with a noble metal precursor. Accordingly, a separate additional doping process may not be required, and such a dopant element may serve to prevent agglomeration during heat treatment for forming the catalyst metal. The dopant element may be formed, for example, on the carrier to promote anchoring of catalytic metal particles.

When the catalyst for a fuel cell further includes the dopant element in this way, an anchoring effect between the dopant element and the metal may be exhibited, and agglomeration of particles may be further reduced. In addition, when manufacturing a fuel cell electrode, catalyst dispersion may be improved through Coulomb interaction with an ionomer.

When the catalyst for a fuel cell is subjected to cyclic voltammetry at 50 mV/s for 4 to 6 cycles under oxygen supply conditions in the voltage range of 0.01 V to 1.2 V, where oxygen reduction reaction is possible, a coating layer having a thickness of less than 5 atomic layers may be formed on the intermetallic compound particles. The coating layer may be formed evenly without a large thickness deviation, and the thickest portion may be 4 atomic layers or less, and the thinnest portion may be 1 atomic layer or more. For example, when the intermetallic compound includes platinum as a noble metal, a platinum coating layer having a thickness of 3 atomic layers or less and 1 atomic layer or more may be formed. If the thickness of the coating layer is 5 atomic layers or more, it may be difficult to obtain the effect of a regular intermetallic compound structure, and an unstable catalyst structure may be formed. On the other hand, if the thickness of the coating layer is less than 1 atomic layer, the effect of enhancing the active site for oxygen reduction reaction may be minimal, and the non-noble metal component on the surface may be dissolved during electrochemical reaction.

If the number of cycles of cyclic voltammetry is less than 4, the coating layer may not be formed, so the effect of enhancing the active site for oxygen reduction reaction may be minimal, and the non-noble metal component on the surface may be dissolved during electrochemical reaction. On the other hand, if the number of cycles of cyclic voltammetry exceeds 6, the coating layer may become excessively thick, making it difficult to obtain the effect of a regular intermetallic compound structure, and an unstable catalyst structure may be formed.

The catalyst for a fuel cell may exhibit a very small decrease in half-wave potential even after 30,000 cycles of accelerated durability testing in the voltage range of 0.6 V to 1.0 V at 500 mV/s under oxygen supply conditions. The ratio of the half-wave potential value after accelerated durability testing based on the half-cell half-wave potential value of 100% before accelerated durability testing may be 95% or more, 96% or more, or 99% or more, and 99.9% or less. The configuration and conditions of the half-cell are as described in the Test Example below.

When the catalyst for a fuel cell includes ternary intermetallic compound particles to which a transition metal is additionally introduced according to the preparation method thereof described below and is doped with nitrogen, the decrease in half-wave potential may be very small even after 150k cycles of accelerated durability testing, and the superlattice structure of the actual intermetallic compound may be maintained.

The average particle size of the intermetallic compound particles may be 8 nm or less, 6 nm or less, or 4 nm or less, and 1 nm or more. If the particle size thereof exceeds 8 nm, the specific surface area of the catalyst may decrease, which may deteriorate electrochemical performance, the conductivity may decrease, which may slow down the oxygen reduction reaction rate, the particles may agglomerate during chemical reaction, which may deteriorate the structural stability of the catalyst, and durability may decrease during long-term reaction. When the catalyst for a fuel cell further includes a dopant element, an agglomeration phenomenon may be minimized and a small particle size may be achieved. Since the intermetallic compound particles have such a particle size, oxygen reduction reaction characteristics may be further improved and durability may be increased. The average particle size may be calculated through an image of the catalyst for a fuel cell obtained by a transmission electron microscope (HRTEM, HRSTEM), and may be calculated using a typical image analysis program (ImageJ), and the like.

The molar ratio of the noble metal to the transition metal of the intermetallic compound particles may be a simple integer ratio, for example, 1:1, 1:2, 1:3, 2:1, 2:3, 3:2, 3:4, 4:3, 4:5, and the like.

The carbon loading of the catalyst for a fuel cell may be 20 wt % or more and 60 wt % or less, or 40 wt % or less based on the total weight thereof.

### Method of Preparing a Catalyst for a Fuel Cell

A method of preparing a catalyst for a fuel cell according to another aspect of the present disclosure includes: (a) obtaining a first mixture by mixing a carrier with a binary metal precursor including a noble metal precursor and a first transition metal precursor; where the method further includes (b1) obtaining the catalyst for a fuel cell according to the present disclosure by heat-treating the first mixture in a reducing atmosphere; or (b2) obtaining a second mixture by heat-treating the first mixture in a reducing atmosphere and adding a second transition metal precursor; and (b3) obtaining the catalyst for a fuel cell according to the present disclosure by heat-treating the mixture containing the second transition metal precursor in a reducing atmosphere.

The second transition metal precursor in step (b2) may not include a nitrate.

The heat treatment temperature in steps (b1) and (b3) may be 400° C. to 800° C.

The noble metal of the noble metal precursor in step (a) may include platinum, palladium, iridium, ruthenium, rhodium, osmium, gold, or any combinations thereof.

The first transition metal of the first transition metal precursor in step (a) and the second transition metal of the second transition metal precursor in step (b2) are different from each other, and each may include cobalt, iron, copper, nickel, or any combinations thereof.

The mixture in step (a) may include a solvent or a dispersion medium, and the solvent may include water, a C1-C5 alcohol compound, acetone, dimethyl sulfoxide (DMSO), dimethyl formamide (DMF), N-methylpyrrolidone (NMP), and the like, and an example thereof may include water.

Step (a) may further include a sonication process, which may be performed for 0.5 to 2 hours.

Step (a) may further include a stirring process, which may be performed at a temperature in a range of 50° C. to 120° C. for 1 hour to 10 hours. Thereby, the solvent may be evaporated from the mixture to obtain a powdered material.

The noble metal precursor in step (a) may include chloroplatinic acid, platinum nitrate, platinum acetylacetonate, platinum carbonate, hydrates, or any combinations thereof.

The first transition metal precursor in step (a) may include cobalt chloride, cobalt nitrate, cobalt sulfate, cobalt carbonate, iron chloride, iron nitrate, iron sulfate, iron carbonate, copper chloride, copper nitrate, copper sulfate, nickel chloride, nickel nitrate, nickel sulfate, nickel carbonate, hydrates, or any combination thereof.

The second transition metal precursor in step (b2) may include cobalt chloride, cobalt sulfate, cobalt carbonate, iron chloride, iron sulfate, iron carbonate, copper chloride, copper sulfate, nickel chloride, nickel sulfate, nickel carbonate, hydrates, or any combinations thereof.

The mixture containing the second transition metal precursor in step (b2) may also include a solvent or dispersion medium, and the solvent may include water, a C1-C5 alcohol compound, acetone, dimethyl sulfoxide (DMSO), dimethyl formamide (DMF), N-methylpyrrolidone (NMP), and the like, and an example thereof may include water.

Step (b2) may further include performing additional sonication on the mixture containing the second transition metal precursor, which may be performed for 0.5 to 2 hours.

Step (b2) may further include stirring the mixture containing the second transition metal precursor, which may be performed at a temperature in a range of 50° C. to 120° C. for 1 hour to 10 hours.

The first transition metal precursor in step (a) may include a nitrate, and thus a nitrogen-doped precatalyst may be obtained in step (a). Also, when a nitrate is used as the first transition metal precursor, an additional nitrogen doping process may not be required and may be omitted. Moreover, when a nitrate is used as the first transition metal precursor, dispersibility of the catalytic metal in the catalyst prepared by the subsequent heat treatment may be further improved.

The molar ratio of the noble metal precursor to the first transition metal precursor in step (a) may be 1:0.2 to 1:5, and depending on the subsequent heat treatment, the molar ratio of the noble metal to the transition metal may converge on any one of the integer ratios described above.

When the second transition metal precursor in step (b2) is added, the molar ratio of the noble metal to the second transition metal of the heat-treated material may be 1:0.2 to 1:5, and depending on the subsequent heat treatment, the molar ratio of the noble metal to the transition metal may converge on any one of the integer ratios described above.

The heat treatment temperature in steps (b1) and (b3) may be in a range of 400° C. to 800° C., 500° C. to 700° C., or 520° C. to 680° C. If the heat treatment temperature is lower than 400° C., the intermetallic compound particles may not be sufficiently formed and an irregular alloy may be formed, whereas if the heat treatment temperature exceeds 800° C., the size of the alloy particles may be too large, which may reduce the reaction area of the alloy particles and thus decrease catalytic activity.

In steps (b1) and (b3), additional heat treatment to 400° C. or higher other than the heat treatment at the temperature described above may not be performed. Specifically, after heat treatment at the temperature described above and cooling, increasing the temperature to 400° C. or higher may not be performed, and a catalyst for a fuel cell may be prepared by single heat treatment in step (b1) or (b3).

The heat treatment in steps (b1) and (b3) may be performed in a reaction vessel containing 1 to 10 vol % of hydrogen gas based on the total volume thereof, and unnecessary components may be easily reduced.

Steps (b1) and (b3) may include increasing the temperature to the level described above. As such, the heating rate may be in a range of 0.5° C./min to 3° C./min.

The heat treatment in steps (b1) and (b3) may be performed for 1 to 5 hours at the heat treatment temperature described above.

A catalyst for a fuel cell obtained by the preparation method according to the present disclosure may have the electrochemical and structural characteristics described above.

### Electrode for a Fuel Cell

An electrode for a fuel cell according to still another aspect of the present disclosure may include the catalyst described above.

The electrode may be an electrode associated with oxygen reduction reaction and may be a cathode (reduction electrode).

The electrode may be employed as a member of a fuel cell, and may be applied to a membrane-electrode assembly, a unit fuel cell including the same, a fuel cell stack, and the like.

When the catalyst includes the dopant element described above, the catalyst may be evenly dispersed by virtue of Coulomb interaction with an ionomer that may be included in the electrode.

A better understanding of the present disclosure may be obtained through the following examples and comparative examples. However, these examples are not to be construed as limiting the technical spirit of the present disclosure.

### Example 1—Preparation of PtCo/C Intermetallic Compound Catalyst

In step (a), 0.4195 g (0.810 mmol) of chloroplatinic acid hexahydrate, 0.1285 g (0.540 mmol) of cobalt (II) chloride hexahydrate, and 0.48 g of Ketjen black (EC-300JD) were weighed and mixed with 100 ml of distilled water in a 250 ml reaction vessel (round bottom flask) to obtain a mixture, followed by sonication for 1 hour. The sonicated mixture was stirred in an oil bath at 90° C. for 4 hours to evaporate the solvent, thus obtaining a powdered PtCo/C material (where Pt is platinum, Co is cobalt, and C is carbon).

In step (b1), 1 g of the powdered PtCo/C material was weighed in a reaction vessel (quartz boat), the reaction vessel was placed in a tube furnace, the internal atmosphere was purged with 5 vol % of hydrogen and 95 vol % of argon, and then the temperature was increased from room temperature (20° C.) to 600° C. at a heating rate of 1° C./min, followed by heat treatment at 600° C. for 2 hours, ultimately obtaining a PtCo/C intermetallic compound catalyst.

### Example 2—Preparation of PtFe/C Intermetallic Compound Catalyst

A PtFe/C (where Fe is iron) intermetallic compound catalyst was obtained under the same conditions as in Example 1, with the exception that the same molar amount of iron (II) chloride tetrahydrate was used as the transition metal precursor in step (a) in lieu of cobalt chloride hexahydrate, and the heat treatment temperature in step (b1) was changed to 800° C.

### Example 3—Preparation of PtCu/C Intermetallic Compound Catalyst

A PtCu/C (where Cu is copper) intermetallic compound catalyst was obtained under the same conditions as in Example 1, with the exception that the same molar amount of copper (II) chloride dihydrate was used as the transition metal precursor in step (a) in lieu of cobalt chloride hexahydrate.

### Example 4—Preparation of PtCo/N—C Intermetallic Compound Catalyst

A PtCo/N—C (where N is nitrogen) intermetallic compound catalyst was obtained under the same conditions as in Example 1, with the exception that the same molar amount of cobalt (II) nitrate hexahydrate was used as the transition metal precursor in step (a) in lieu of cobalt chloride hexahydrate.

### Example 5—Preparation of PtCoNi/C Intermetallic Compound Catalyst

In step (b2), the PtCo/C intermetallic compound catalyst obtained in Example 1 and 0.070 g (0.540 mmol) of nickel chloride hydrate were weighed and mixed with 100 ml of distilled water in a 250 ml reaction vessel (round bottom flask) to obtain a mixture, followed by sonication for 1 hour. The sonicated mixture was stirred in an oil bath at 90° C. for 4 hours to evaporate the solvent, thus obtaining a powdered PtCoNi/C material (where Ni is nickel).

In step (b3), 1 g of the powdered PtCoNi/C material was weighed in a reaction vessel (quartz boat), the reaction vessel was placed in a tube furnace, and the internal atmosphere was purged with 5 vol % of hydrogen and 95 vol % of argon, and then the temperature was increased from room temperature (20° C.) to 600° C. at a heating rate of 1° C./min, followed by heat treatment at 600° C. for 2 hours, ultimately obtaining a PtCoNi/C intermetallic compound catalyst.

### Example 6—Preparation of PtCoNi/N—C Intermetallic Compound Catalyst

A PtCoNi/N—C intermetallic compound catalyst was obtained under the same conditions as in Example 5, with the exception that the same molar amount of cobalt (II) nitrate hexahydrate was used as the transition metal precursor in step (b2) in lieu of cobalt chloride hexahydrate.

### Comparative Example 1—Preparation of PtCoNi Catalyst

First, 0.4195 g (0.810 mmol) of chloroplatinic acid hexahydrate, 0.1285 g (0.540 mmol) of cobalt (II) nitrate hexahydrate, 0.070 g (0.540 mmol) of nickel chloride hydrate, and 0.48 g of Ketjen black (EC-300JD) were weighed and mixed with 100 ml of distilled water in a 250 ml reaction vessel (round bottom flask) to obtain a mixture, followed by sonication for 1 hour. The sonicated mixture was stirred in an oil bath at 90° C. for 4 hours to evaporate the solvent, thus obtaining a powdered PtCoNi/C-containing material.

Then, 1 g of the PtCoNi/C-containing material was weighed in a reaction vessel (quartz boat), the reaction vessel was placed in a tube furnace, and the internal atmosphere was purged with 5 vol % of hydrogen and 95 vol % of argon, and then the temperature was increased from room temperature (20° C.) to 600° C. at a heating rate of 1° C./min, followed by heat treatment at 600° C. for 2 hours, ultimately obtaining a PtCoNi/C catalyst.

### Comparative Example 2—Preparation of PtCoNi/N—C Catalyst

A PtCoNi/N—C catalyst was obtained under the same conditions as in Example 5, with the exception that the same molar amount of nickel (II) nitrate hexahydrate was used as the transition metal precursor in step (b2) in lieu of nickel chloride hydrate.

### Comparative Example 3—Preparation of PtCo/N—C Catalyst

A PtCo/N—C catalyst was obtained under the same conditions as in Example 4, with the exception that the heat treatment temperature in step (b1) was changed to 200° C.

### Comparative Example 4—Preparation of PtCoNi/N—C Catalyst

A PtCoNi/N—C catalyst was obtained under the same conditions as in Example 6, with the exception that the heat treatment temperature in step (b3) was changed to 100° C.

The conditions of the Examples and Comparative Examples are shown in Table 1 below.

TABLE 1

| | | | (b1) or (b3) | | |
|---|---|---|---|---|---|
| | | (b2) Transition | Heat | | |
| | (a) Transition | metal | treatment | Metal molar | Doping with |
| Classification | metal precursor | precursor | temperature | ratio | nitrogen |
| Example 1 | Cobalt chloride | — | 600° C. | Pt:Co 3:2 | X |
| | hexahydrate | | | | |
| Example 2 | Iron chloride | — | 800° C. | Pt:Fe 3:2 | X |
| | tetrahydrate | | | | |
| Example 3 | Copper chloride | — | 600° C. | Pt:Cu 3:2 | X |
| | dihydrate | | | | |
| Example 4 | Cobalt nitrate | — | 600° C. | Pt:Co 3:2 | ◯ |
| | hexahydrate | | | | |
| Example 5 | Cobalt chloride | Nickel chloride | 600° C. | Pt:Co:Ni 3:2:2 | X |
| | hexahydrate | hydrate | | | |
| Example 6 | Cobalt nitrate | Nickel chloride | 600° C. | Pt:Co:Ni 3:2:2 | ◯ |
| | hexahydrate | hydrate | | | |
| Comparative | Cobalt nitrate | — | 600° C. | Pt:Co:Ni 3:2:2 | ◯ |
| Example 1 | hexahydrate, | | | | |
| | Nickel chloride | | | | |
| | hexahydrate | | | | |
| Comparative | Cobalt chloride | Nickel nitrate | 600° C. | Pt:Co:Ni 3:2:2 | ◯ |
| Example 2 | hexahydrate | hexahydrate | | | |
| Comparative | Cobalt nitrate | — | 200° C. | Pt:Co 3:2 | ◯ |
| Example 3 | hexahydrate | | | | |
| Comparative | Cobalt nitrate | Nickel chloride | 100° C. | Pt:Co:Ni 3:2:2 | ◯ |
| Example 4 | hexahydrate | hydrate | | | |

### Test Example 1—Transmission Electron Microscopy (TEM) and X-Ray Diffraction Analysis

The catalysts of the Examples and Comparative Examples were observed using a transmission electron microscope, and X-ray diffraction analysis was performed.

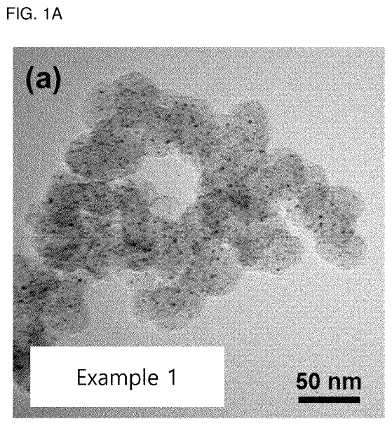

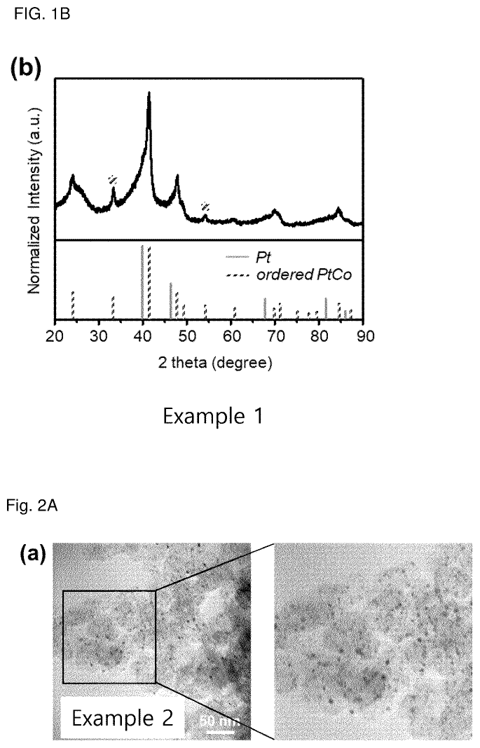

FIG. 1A and FIG. 1B show TEM and XRD results of Example 1, respectively. Referring thereto, Example 1 showed that PtCo nanoparticles with a size of about 2-3 nm were evenly dispersed on the carbon carrier. Also, superlattice peaks corresponding to the (100) and (111) planes of the intermetallic compound were observed at 2 theta values of about 33° and 54°, respectively, in the XRD spectrum, indicating that the Pt and Co atoms were regularly arranged.

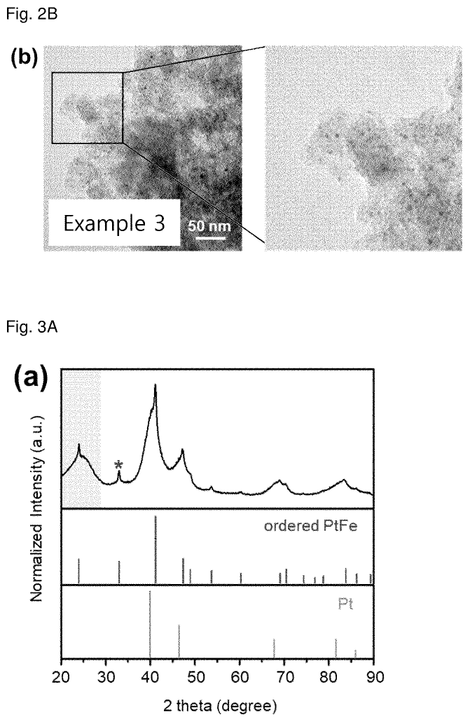

FIG. 2A and FIG. 2B show TEM results of Example 2 and Example 3, respectively, and FIG. 3A and FIG. 3B show XRD results of Example 2 and Example 3, respectively. Referring thereto, Examples 2 and 3 showed that PtFe nanoparticles and PtCu nanoparticles with a size of 3-4 nm were evenly dispersed on the carbon carrier. Moreover, as confirmed in the XRD spectrum, Example 2 had a superlattice peak at 2 theta around 33°, and Example 3 had a superlattice peak at 2 theta around 20°. Thereby, it can be found that Pt and Fe atoms and Pt and Cu atoms were regularly arranged in the PtFe nanoparticles of Example 2 and the PtCu nanoparticles of Example 3, respectively.

FIG. 4A and FIG. 4B show TEM and XRD results of Example 4, respectively. Referring thereto, Example 4 showed that PtCo nanoparticles with a size of about 2-3 nm were evenly dispersed on the carbon carrier. Also, superlattice peaks corresponding to the (100) and (111) planes of the intermetallic compound were observed at 2 theta values of about 33° and 54°, respectively, in the XRD spectrum. Thereby, it can be found that Pt and Co were regularly arranged in the PtCo nanoparticles of the PtCo/N—C intermetallic compound nanocatalyst.

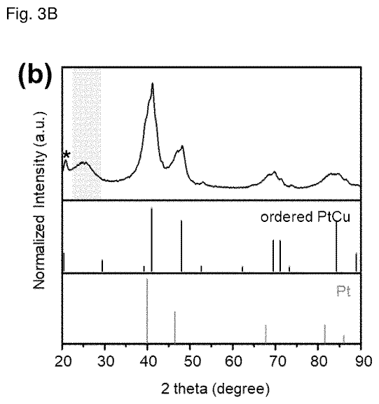

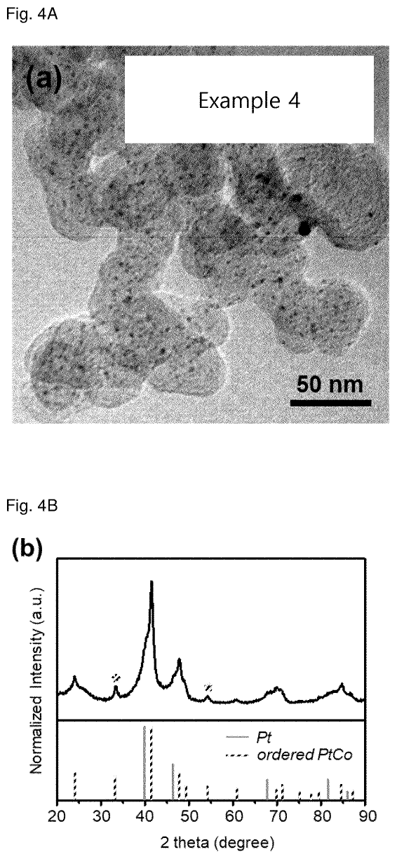

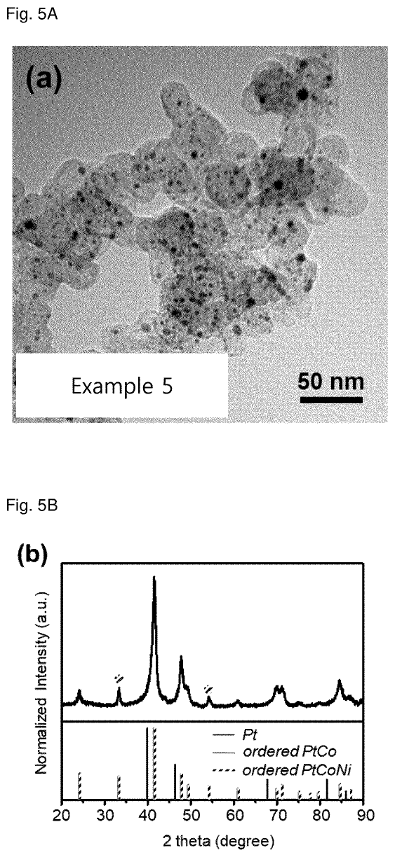

FIG. 5A and FIG. 5B show TEM and XRD results of Example 5, respectively. Referring thereto, Example 5 showed that PtCoNi nanoparticles with a size of about 5-6 nm were evenly dispersed on the carbon carrier. In Example 5, the peak position shifted to the right in the XRD spectrum due to Ni introduction, which is deemed to be because lattice shrinkage was caused by introduction of Ni having a smaller ion size than Co into the PtCo intermetallic compound lattice. Also, superlattice peaks corresponding to the (100) and (111) planes of the intermetallic compound were observed at 2 theta values of about 33° and 54°, respectively, in the XRD spectrum. Thereby, it can be found that Pt and Co or Ni were regularly arranged in the PtCoNi nanoparticles of the PtCoNi/C intermetallic compound nanocatalyst.

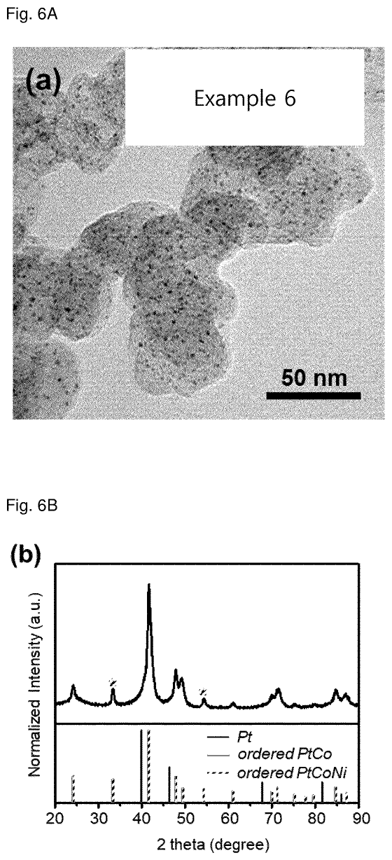

FIG. 6A and FIG. 6B show TEM and XRD results of Example 6, respectively. Referring thereto, Example 6 showed that PtCoNi nanoparticles with a size of about 3 nm were evenly dispersed on the carbon carrier. Also, substantially the same superlattice peaks as in Example 5 were observed in the XRD spectrum. Thereby, it can be found that the PtCoNi nanoparticles of the PtCoNi/N—C intermetallic compound nanocatalyst did not agglomerate and were maintained small and also that Pt and Co or Ni were regularly arranged.

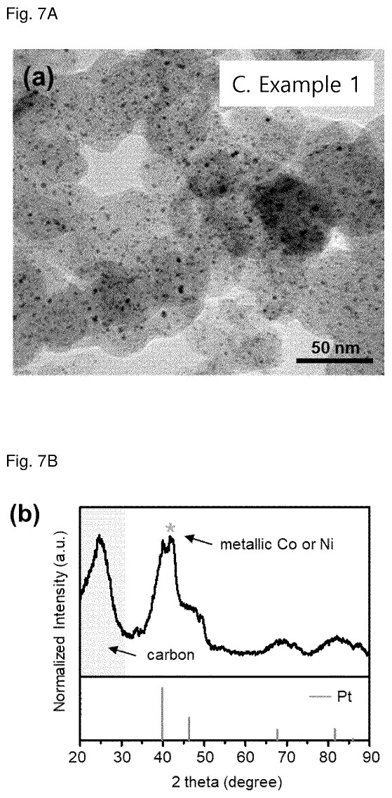

FIG. 7A and FIG. 7B show TEM and XRD results of Comparative Example 1, respectively. Referring thereto, the particle size of Comparative Example 1 increased to about 5 nm compared to the PtCoNi/N—C intermetallic compound catalyst of Example 6. Also, peaks identified as Pt metal and Co or Ni metal were observed in the XRD spectrum, indicating that no intermetallic compound was formed.

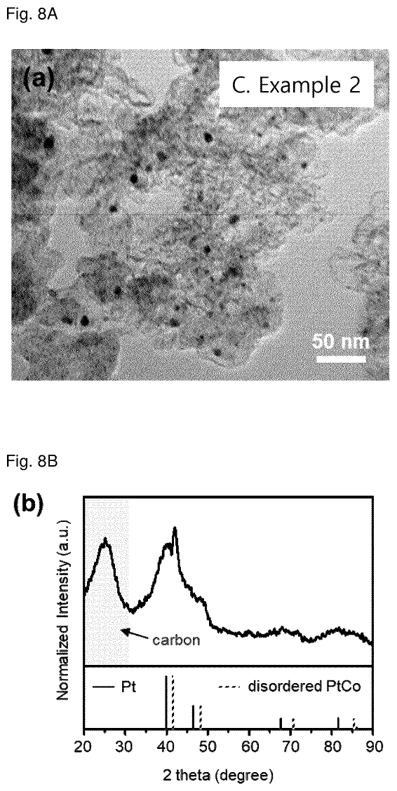

FIG. 8A and FIG. 8B show TEM and XRD results of Comparative Example 2, respectively. Referring thereto, in Comparative Example 2, the particle size increased to about 7 nm compared to the PtCoNi/N—C intermetallic compound catalyst of Example 6, and there were many portions where the particles agglomerated. Also, alloy peaks such as PtCo as well as Pt metal were observed in the XRD spectrum, indicating that no intermetallic compound was formed.

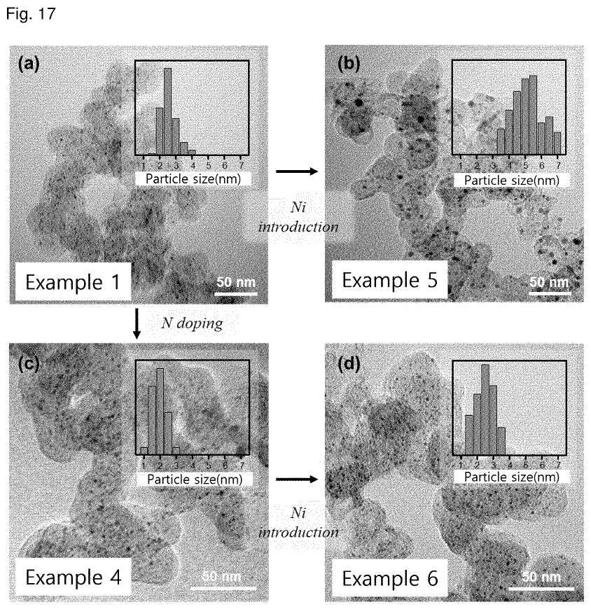

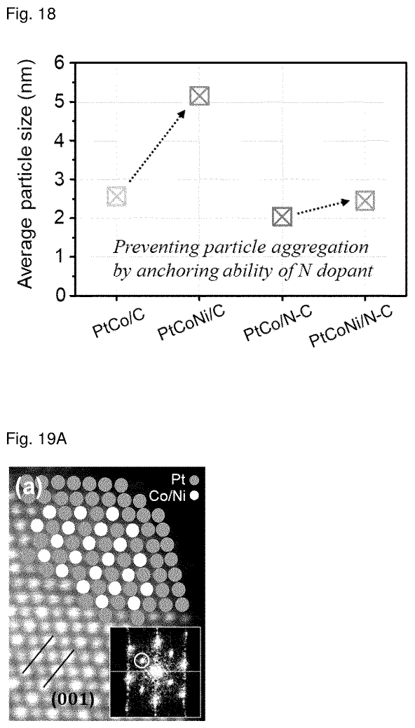

FIGS. 17 and 18 show TEM results of effects of N doping and Ni introduction on the size of the intermetallic compound particles in Examples 1, 4, 5, and 6 respectively. Referring thereto, during synthesis of the binary PtCo-based intermetallic compound nanocatalyst, the average size of the nanoparticles decreased by about 0.5-1 nm due to doping of the carbon carrier with N. Moreover, when Ni was additionally introduced using the PtCo/C intermetallic compound nanocatalyst without N on the carbon carrier as a raw material, the particle size increased to about 5-6 nm, and there were many portions where the particles agglomerated. On the other hand, when Ni was additionally introduced using the PtCo/N—C intermetallic compound nanocatalyst with N on the carbon carrier as a raw material, the size of the PtCoNi intermetallic compound particles was maintained at about 2-3 nm, similar to that of the intermetallic compound particles of the PtCo/N—C intermetallic compound catalyst.

Therefore, the N dopant was confirmed to primarily prevent agglomeration of the PtCo intermetallic compound during the heat treatment process for formation thereof, and also to prevent agglomeration of PtCoNi particles even during the heat treatment process after Ni introduction.

### Test Example 2—High-Resolution Scanning Transmission Electron Microscopy (HRSTEM), Energy Dispersive X-Ray Spectroscopy (EDS), and Fast Fourier Transform (FFT) Pattern Analysis

High-resolution scanning transmission electron microscopy of some examples and corresponding fast Fourier transform pattern analysis, energy dispersive X-ray spectroscopy analysis, etc. were performed and whether intermetallic compounds were formed was cross-verified.

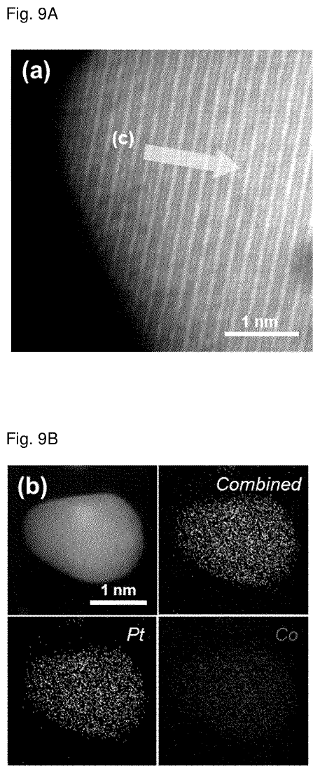

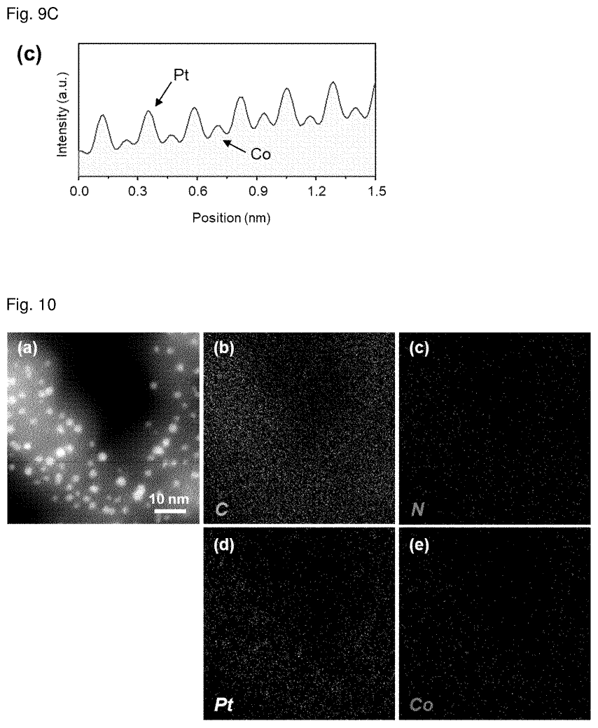

FIG. 9A, FIG. 9B, and FIG. 9C show high-resolution scanning transmission electron microscopy results of Example 4 and a fast Fourier transform (FFT) pattern along the [100] zone axis, respectively. Referring thereto, Pt and Co atoms were regularly arranged, and in the FFT pattern measured in the [100] zone axis, a spot indicating a superlattice for the (001) plane of the intermetallic compound was observed. Also, Pt and Co were evenly distributed and had a regular arrangement such as Pt—Co—Pt— in the Z-contrast intensity profile of the FFT pattern.

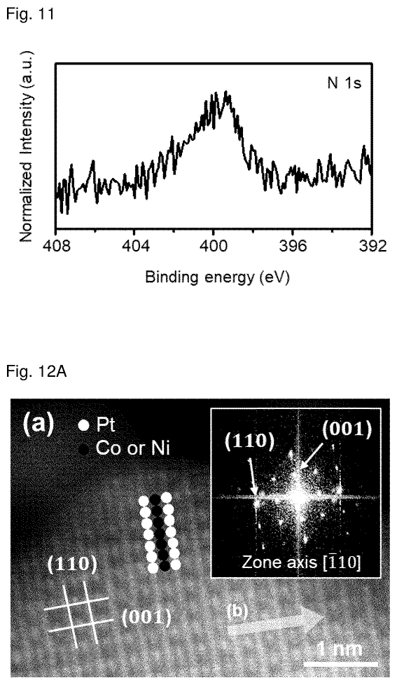

FIG. 10 shows high-angle annular dark-field scanning transmission electron microscopy results of Example 4 and EDS mapping images, respectively, and FIG. 11 shows binding energy results of nitrogen (1s) of Example 4 according to X-ray photoelectron spectroscopy. Referring thereto, Example 4 showed that the carbon carrier was evenly doped with N. Also, based on the XPS results, the presence of N in the carbon carrier was also confirmed.

FIG. 12A and FIG. 12B show high-resolution scanning transmission electron microscopy results of Example 6 and a fast Fourier transform pattern along the [110] zone axis, respectively. Referring thereto, Pt and Co or Ni atoms were regularly arranged, and in the FFT pattern measured in the [110] zone axis, spots indicating a superlattice for the (110) and (001) planes of the intermetallic compound were observed. Also, a regular arrangement such as Pt-M-Pt-M-Pt-M (in which M is Co or Ni) was confirmed in the Z-contrast intensity profile of the FFT pattern.

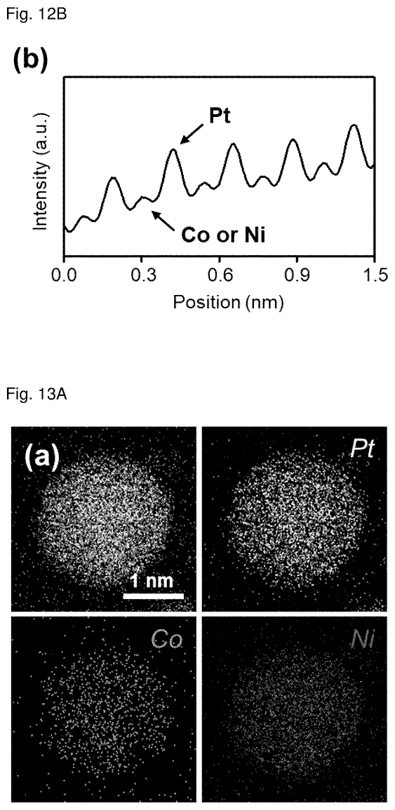

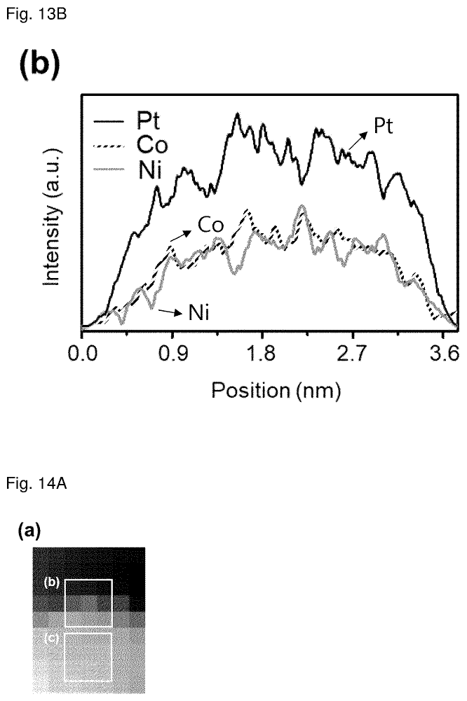

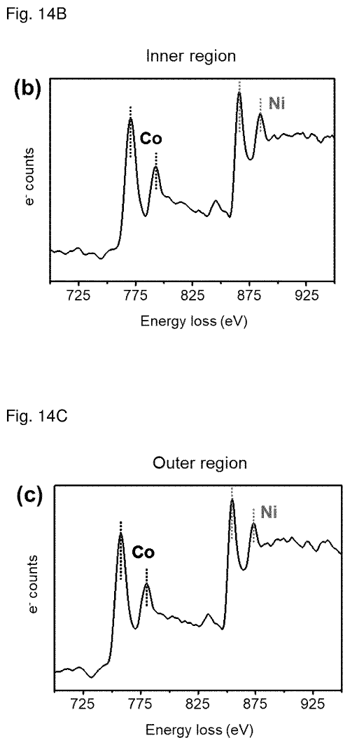

FIG. 13A and FIG. 13B show EDS mapping images of Example 6 and line profile analysis results, respectively, and FIG. 14A, FIG. 14B, and FIG. 14C show electron energy loss spectrum (EELS) results thereof. Referring thereto, Example 6 showed that Pt, Co, and Ni were evenly distributed throughout the PtCoNi intermetallic compound nanoparticles. In addition, Ni and Co were uniformly mixed and present inside and outside the PtCoNi intermetallic compound nanoparticles. Thereby, it can be found that Ni atoms were incorporated and moved from the outside to the inside of the PtCo/N—C intermetallic compound catalyst used as the raw material during the heat treatment in step (b3) of Example 6.

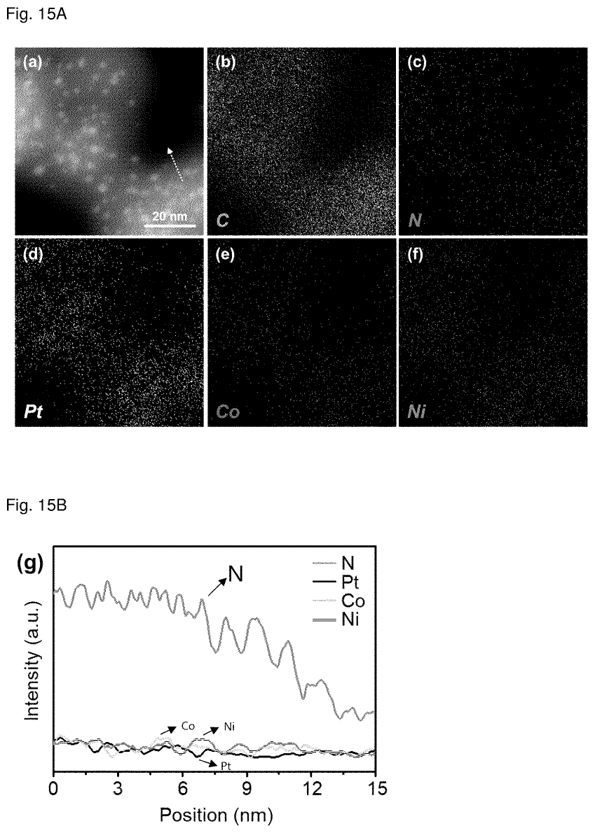

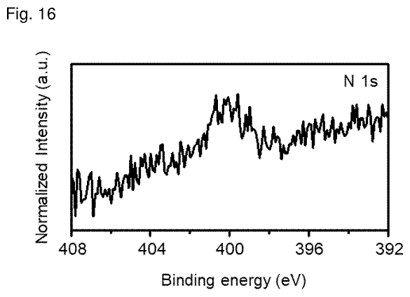

FIG. 15A shows high-angle annular dark-field scanning transmission electron microscopy results of Example 6, EDS mapping images, and FIG. 15B shows line profile analysis results, respectively. FIG. 16 shows binding energy results of nitrogen (1s) of Example 6 according to X-ray photoelectron spectroscopy. Referring thereto, the carbon carrier of the PtCoNi intermetallic compound catalyst of Example 6 was uniformly doped with N. N was present in the PtCo/N—C intermetallic compound catalyst, which is the preparation raw material of Example 6, and doping with N was maintained even upon heat treatment after Ni introduction.

### Test Example 3—Evaluation of Oxygen Reduction Reaction Performance

For the catalysts of the Examples and Comparative Examples, linear sweep voltammetry (LSV) was performed at 20 mV/s for 10 cycles in the voltage range of 0.05 V↔1.1 V where oxygen reduction reaction occurred. Specifically, a three-electrode system was configured to include a platinum wire or graphite rod as a counter electrode, Ag/AgCl (where Ag=silver and Cl=chlorine) or RHE (reversible hydrogen electrode) as a reference electrode, and a glass carbon electrode coated with a catalyst to be measured as a working electrode. 0.1 M HClO₄ (wherein H=hydrogen and O=oxygen) was used as an electrolyte, and after purging with oxygen gas, the test was performed at a rate of 20 mV/s. After cyclic voltammetry, high-resolution scanning transmission electron microscopy and energy dispersive X-ray spectroscopy (EDS) were performed.

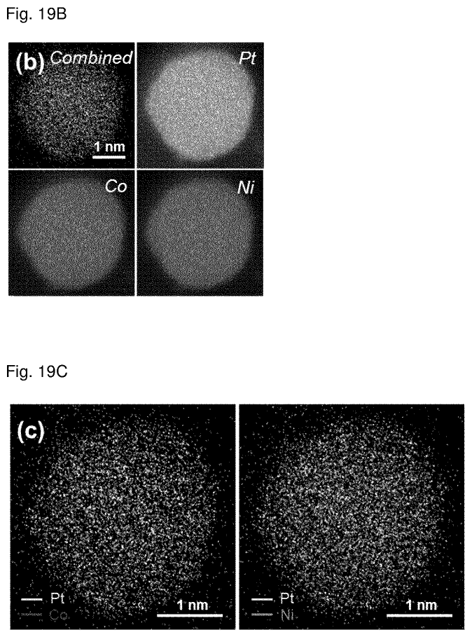

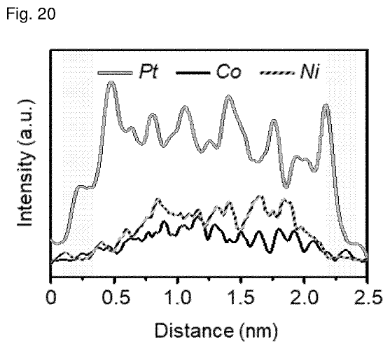

FIG. 19A, FIG. 19B, FIG. 19C show high-resolution scanning transmission electron microscopy results of Example 6 and EDS mapping results, respectively, and FIG. 20 shows EDS line profile analysis results thereof. Referring thereto, in Example 6, some of the Co/Ni metal was removed from the surface of the PtCoNi intermetallic compound particles, forming a Pt layer having a thickness of about 2 atomic layers. Therefore, it was confirmed that a Pt layer that may act as the active site for oxygen reduction reaction was well formed on the surface of the PtCoNi intermetallic compound particles through an activation process using an electrochemical treatment method.

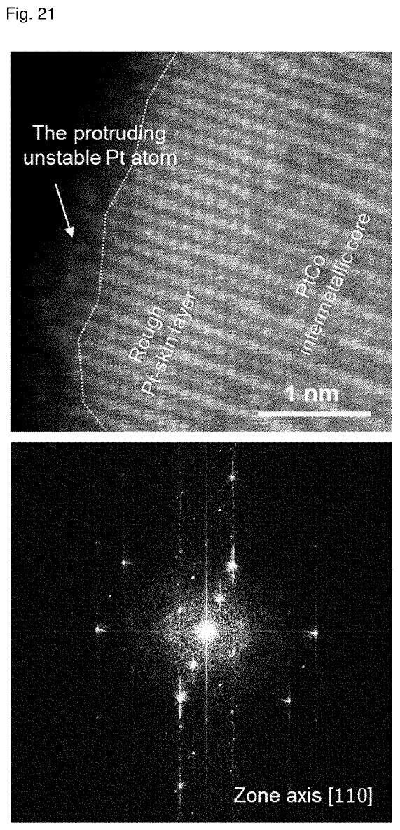

FIG. 21 shows high-resolution scanning transmission electron microscopy (HRSTEM) results of Comparative Example 3. Referring thereto, in Comparative Example 3, a Pt layer with an extremely rough surface and unstably protruding Pt atoms was formed despite undergoing the same electrochemical treatment method as above, and there was a portion exceeding a thickness of 5 atomic layers.

### Test Example 4—Evaluation of Electrochemical Characteristics in a Half-Cell

The catalysts of the Examples and Comparative Examples were used to configure a half-cell system with three electrodes and the electrochemical characteristics thereof were evaluated. A glass carbon electrode was employed as the working electrode, a saturated silver chloride (Ag/AgCl) electrode as the reference electrode, and a graphite rod as the counter electrode. A rotating disc electrode using the glass carbon electrode coated with the catalyst to be measured was employed. A CHI potentiostat was used for all electrochemical evaluations, and oxygen reduction reaction (ORR) was measured using a 0.1 M HClO₄ solution at a rotation speed of 1,600 rpm (revolutions per minute). The voltage was switched relative to a reversible hydrogen electrode (RHE), and a polarization curve corrected for the resistance of the aqueous solution was plotted.

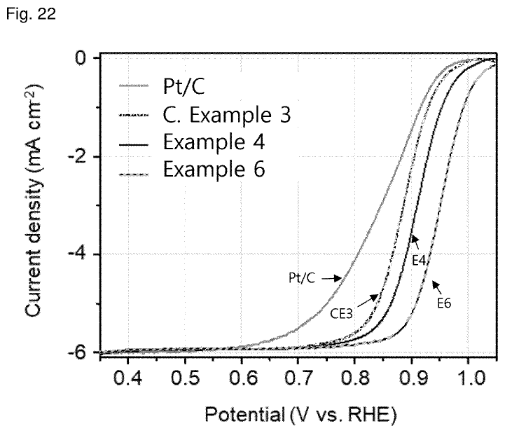

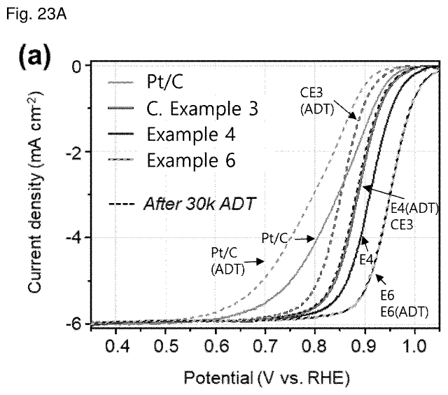

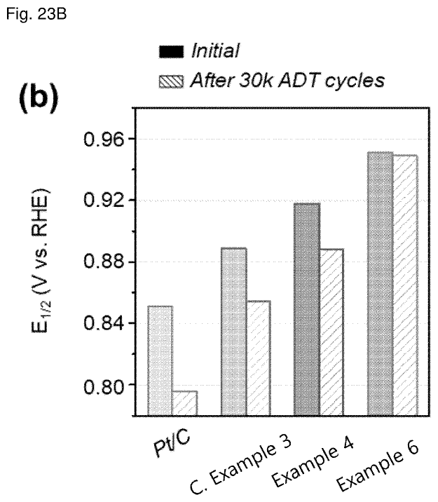

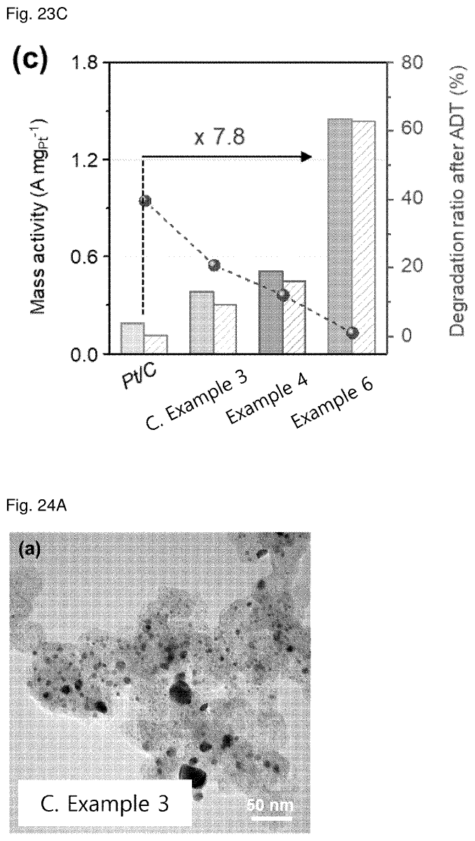

FIG. 22 is a graph showing results of linear sweep voltammetry (LSV) measured with the three-electrode system for the Pt/C catalyst and the catalysts of Example 4, Example 6, and Comparative Example 3, and Table 2 below shows the half-wave potentials of individual catalysts. Referring thereto, the activity of the catalyst containing intermetallic compound particles was found to greatly increase compared to the alloy nanocatalyst based on results of comparison of the half-wave potential (E_{1/2}) values. This means that the oxygen reduction reaction activity was significantly improved due to formation of the intermetallic compound, additional introduction of Ni, etc.

TABLE 2

| Classification | Half-wave potential |
|---|---|
| Commercial Pt/C | 0.851 V |
| Comparative Example 3 | 0.889 V |
| Example 4 | 0.918 V |
| Example 6 | 0.951 V |

Furthermore, half-cell performance was evaluated after accelerated durability testing of the catalysts of the Examples and Comparative Examples. Accelerated durability testing was performed in the voltage range of 0.6 V-1.0 V at 500 mV/s for 30,000 cycles under oxygen supply conditions, and a change in the activity of each catalyst before and after accelerated durability testing was measured.

FIG. 23A, FIG. 23B, and FIG. 23C show the oxygen reduction reaction polarization curve, half-wave potential, and activity change, respectively, of each of Pt/C and the catalysts of Comparative Example 3, Example 4, and Example 6 before and after 30k cycles of accelerated durability testing, and Table 3 below shows the half-wave potential and activity values. Referring thereto, the change in half-wave potential and the change in catalytic activity before and after accelerated durability testing may be confirmed.

TABLE 3

| | | Half-wave | | Mass activity |
|---|---|---|---|---|
| | Half-wave | potential | Mass activity | after ADT |
| Classification | potential | after ADT | (A/mgPt) | (A/mgPt) |
| Commercial Pt/C | 0.851 V | 0.796 V | 0.187 | 0.113 |
| Comparative | 0.889 V | 0.854 V | 0.381 | 0.302 |
| Example 3 | | | | |
| Example 4 | 0.918 V | 0.888 V | 0.509 | 0.448 |
| Example 6 | 0.951 V | 0.949 V | 1.451 | 1.437 |

Referring to Table 3, the intermetallic compound nanocatalyst of Example 6 in which both Ni and N were present exhibited excellent durability in which the half-wave potential decreased by about 0.21% even after 30k cycles of accelerated durability testing (ADT). In addition, mass activity showed a tendency to increase by about 7.8 times in Example 6 compared to the commercial Pt/C catalyst.

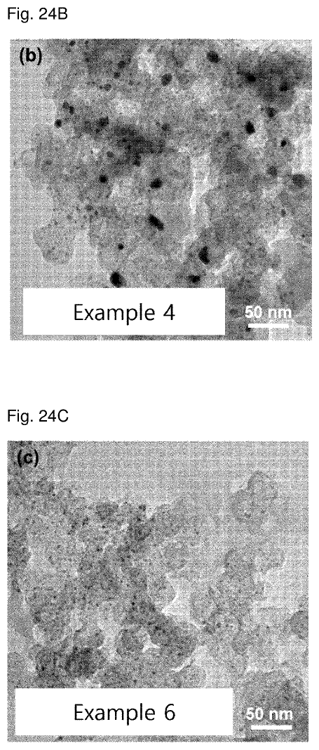

FIG. 24A, FIG. 24B, and FIG. 24C show transmission electron microscopy results of the catalysts of Comparative Example 3, Example 4, and Example 6 after 30k cycles of accelerated durability testing respectively. Referring thereto, in Comparative Example 3, many large portions where the particles on the carbon carrier agglomerated were observed compared to Examples, indicating that Examples had a more solid and stable structure. In Example 6, the particles did not agglomerate and were maintained in a uniformly small size even after accelerated durability testing.

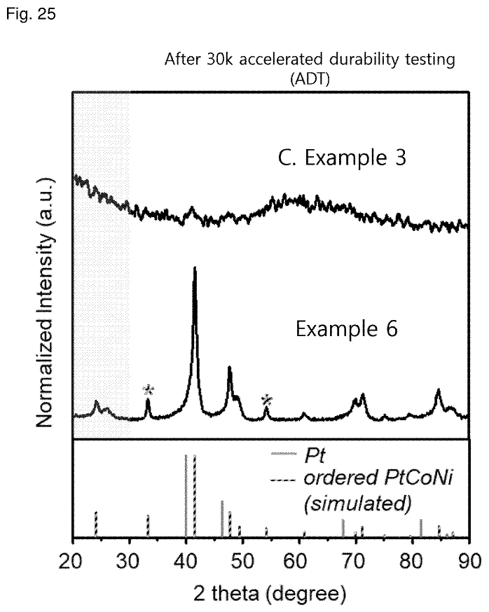

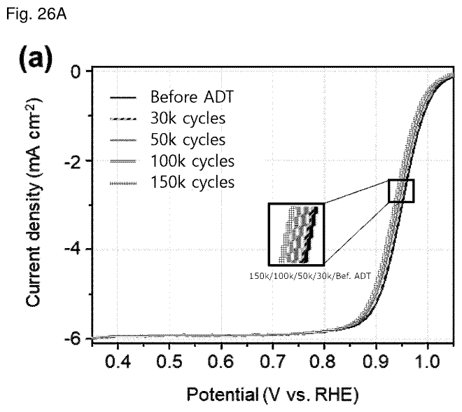

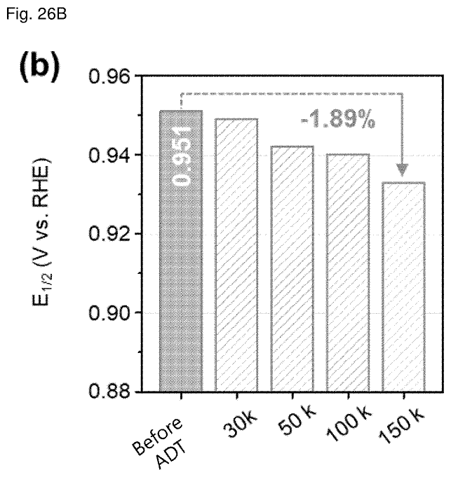

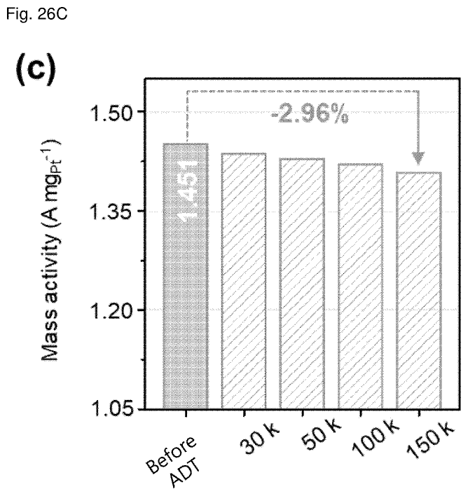

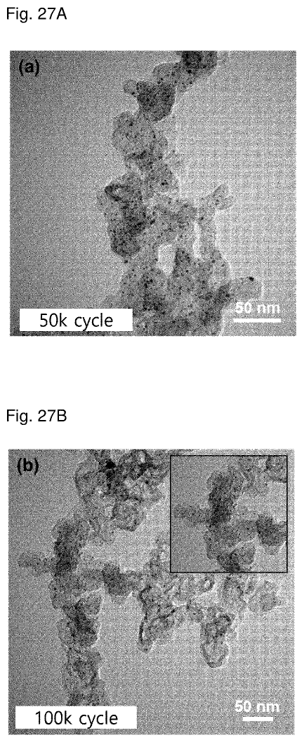

FIG. 25 shows spectra obtained by X-ray diffraction analysis of the catalysts of Example 4 and Example 6 after 30k cycles of accelerated durability testing. Referring thereto, Example 4 showed that the crystallinity was broken, and Example 6 showed that the intermetallic compound phase was maintained and had a stable structure.

FIG. 26A, FIG. 26B, and FIG. 26C show the oxygen reduction reaction polarization curve, half-wave potential, and activity change, respectively, of Example 6 before and after 50k, 100k, and 150k cycles of accelerated durability testing, in which the number of cycles of accelerated durability testing was increased. Referring thereto, in Example 6, even after 150k cycles of accelerated durability testing, there was no significant change in activity, and the half-wave potential showed a small decrease of about 1.89% and the mass activity showed a small decrease of about 2.96%.

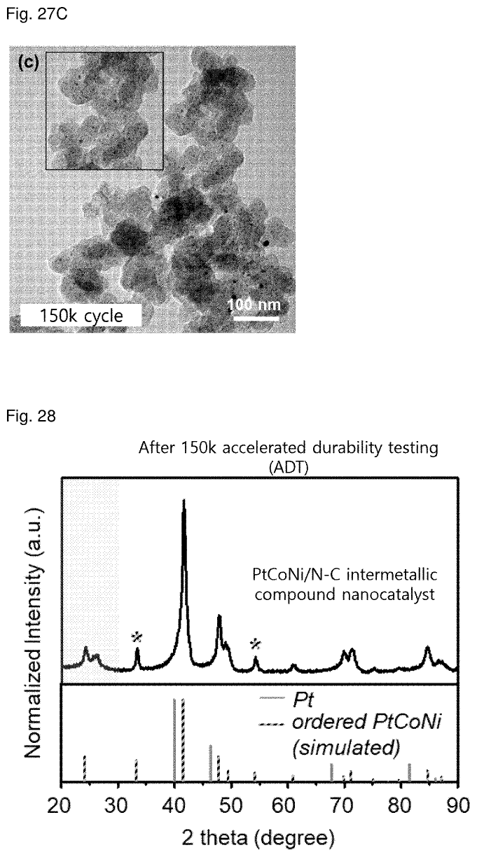

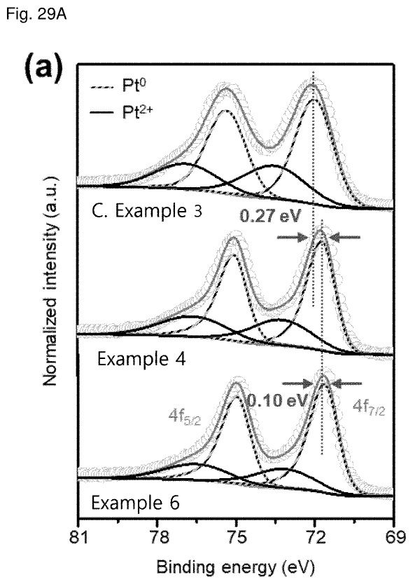

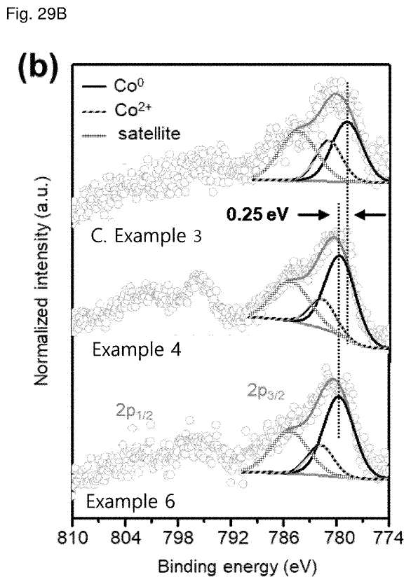

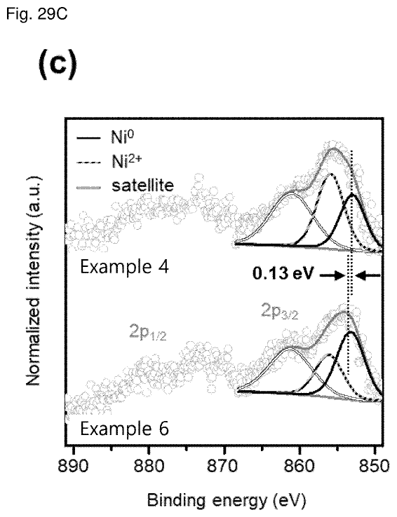

FIG. 27A, FIG. 27B, and FIG. 27C show transmission electron microscopy results of Example 6 after 50k, 100k, and 150k cycles of accelerated durability testing respectively. FIG. 28 shows X-ray diffraction analysis spectrum of Example 6 after 150k cycles of accelerated durability testing. Referring thereto, Example 6 showed that the intermetallic compound phase remained stable even after 150k cycles of accelerated durability testing.

### Test Example 5—X-Ray Photoelectron Spectroscopy

The chemical binding state and oxidation state of the nanoparticles of the catalysts of the Examples and Comparative Examples were confirmed through X-ray photoelectron spectroscopy.

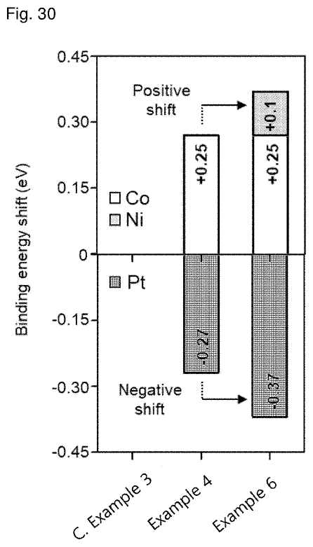

FIG. 29A, FIG. 29B, and FIG. 29C shows XPS spectra of the binding energy peaks of Pt⁰ and Pt²⁺, Co⁰ and Co²⁺, Ni⁰ and Ni²⁺ of Comparative Example 3, Example 4, and Example 6 respectively. FIG. 30 is a graph showing a change in binding energy for each element in Comparative Example 3, Example 4, and Example 6. Referring thereto, Example 4, compared to Comparative Example 3, showed a difference of about 0.27 eV in the peaks corresponding to zerovalent and divalent Pt toward the lower binding energy, and a difference of about 0.25 eV in the peaks corresponding to zerovalent and divalent Co toward the higher binding energy. This is deemed to be because the PtCo intermetallic compound was formed in Example 4 and thus some electrons at the Co position moved to the Pt position.

Example 6 showed an additional difference of about 0.1 eV in the peaks corresponding to zerovalent and divalent Pt toward the lower binding energy, and a difference of about 0.13 eV in the peaks corresponding to zerovalent and divalent Ni toward the higher binding energy, compared to Example 4. As such, no substantial difference in the Co peak positions was observed in these catalysts. These results suggest that some electrons at the Ni position additionally moved to the Pt position as the PtNi intermetallic compound was formed. Therefore, Example 6 showed that the electron density at the Pt position was significantly increased by the additionally introduced Ni.

As is apparent from the foregoing, a catalyst for a fuel cell according to the present disclosure can prevent agglomeration and include intermetallic compound particles having a small size.

Moreover, in the catalyst for a fuel cell according to the present disclosure, some electrons at the transition metal position move to the noble metal position compared to an irregular alloy catalyst, thus increasing the electron density at the noble metal position, and the noble metal binding energy peak position changes in the XPS spectrum, thus improving oxygen reduction reaction (ORR).

In addition, a method of preparing a catalyst for a fuel cell according to the present disclosure has a simplified process, making it easy to mass-produce and ensure economic feasibility.

The effects of the present disclosure are not limited to the foregoing. It should be understood that the effects of the present disclosure include all effects that can be inferred from the description of the present disclosure.

Although specific embodiments of the present disclosure have been described, those having ordinary skill in the art will appreciate that the present disclosure may be embodied in other specific forms without changing the technical spirit or essential features thereof. Thus, the embodiments described above should be understood to be non-limiting and illustrative in every way.

What is claimed is:

1. A catalyst for a fuel cell, the catalyst comprising:
a carrier, and
intermetallic compound particles supported on the carrier,
wherein the intermetallic compound particles include a noble metal and a transition metal,
wherein a peak representing a superlattice is present in a spectrum obtained by X-ray diffraction analysis, and
wherein a decrease in a position of a noble metal binding energy peak of the catalyst including the intermetallic compound particles is 0.1 eV or more, based on a noble metal binding energy peak of a catalyst including irregular alloy particles of identical noble metal-transition metal components in a noble metal binding energy-intensity spectrum obtained by X-ray photoelectron spectroscopy.

2. The catalyst of claim 1, wherein:
the noble metal comprises platinum, palladium, iridium, ruthenium, rhodium, osmium, gold, or any combinations thereof, and
the transition metal comprises cobalt, iron, copper, nickel, or any combinations thereof.

3. The catalyst of claim 2, wherein the intermetallic compound particles comprise a structure in which the noble metal and the transition metal are alternately arranged in a predetermined direction.

4. The catalyst of claim 2, wherein the intermetallic compound particles comprise platinum-cobalt, platinum-iron, platinum-copper, platinum-cobalt-nickel, or any combinations thereof.

5. The catalyst of claim 4, wherein:
in the spectrum obtained by X-ray diffraction analysis,
peaks representing a superlattice of the intermetallic compound particles comprising platinum-cobalt are present at 32-34° and 53-55°,
a peak representing a superlattice of the intermetallic compound particles comprising platinum-iron is present at 32-34°,
a peak representing a superlattice of the intermetallic compound particles comprising platinum-copper is present at 19-21°, and
peaks representing a superlattice of the intermetallic compound particles comprising platinum-cobalt-nickel are present at 32-34° and 53-55°.

6. The catalyst of claim 1, wherein the carrier comprises carbon and a dopant element containing nitrogen.

7. The catalyst of claim 1, wherein a coating layer having a thickness of less than 5 atomic layers is formed on the intermetallic compound particles when cyclic voltammetry is performed at 50 mV/s for 4 to 6 cycles under oxygen supply conditions in a voltage range of 0.01 V to 1.2 V, where an oxygen reduction reaction is possible.

8. The catalyst of claim 1, wherein an average particle size of the intermetallic compound particles is 8 nm or less.

9. The catalyst of claim 6, wherein an average particle size of the intermetallic compound particles is 4 nm or less.

10. A method of preparing a catalyst for a fuel cell, the method comprising:
obtaining a first mixture by mixing a carrier with a binary metal precursor comprising a noble metal precursor and a first transition metal precursor; wherein the method further comprises:
obtaining the catalyst of claim 1 by heat-treating the first mixture in a reducing atmosphere; or
obtaining a second mixture by heat-treating the first mixture in a reducing atmosphere and adding a second transition metal precursor, and obtaining the catalyst of claim 1 by heat-treating the second mixture containing the second transition metal precursor in a reducing atmosphere,
wherein the second transition metal precursor does not comprise a nitrate, and
wherein a heat treatment temperature is in a range of 400° C. to 800° C.

11. The method of claim 10, wherein an additional heat treatment to 400° C. or higher is not performed.

12. The method of claim 10, wherein:
a noble metal of the noble metal precursor comprises platinum, palladium, iridium, ruthenium, rhodium, osmium, gold, or any combinations thereof, and
a first transition metal of the first transition metal precursor and a second transition metal of the second transition metal precursor are different from each other and each comprises cobalt, iron, copper, nickel, or any combinations thereof.

13. The method of claim 12, wherein:
the noble metal precursor comprises chloroplatinic acid, platinum nitrate, platinum acetylacetonate, platinum carbonate, hydrates, or any combinations thereof,
the first transition metal precursor comprises cobalt chloride, cobalt nitrate, cobalt sulfate, cobalt carbonate, iron chloride, iron nitrate, iron sulfate, iron carbonate, copper chloride, copper nitrate, copper sulfate, nickel chloride, nickel nitrate, nickel sulfate, nickel carbonate, hydrates, or any combinations thereof, and
the second transition metal precursor comprises cobalt chloride, cobalt sulfate, cobalt carbonate, iron chloride, iron sulfate, iron carbonate, copper chloride, copper sulfate, nickel chloride, nickel sulfate, nickel carbonate, hydrates, or any combinations thereof.

14. The method of claim 13, wherein the first transition metal precursor comprises a nitrate.

15. The method of claim 10, wherein a molar ratio of the noble metal precursor to the first transition metal precursor is 1:0.2 to 1:5.

16. The method of claim 10, wherein the first mixture further comprises a solvent.

17. The method of claim 16, wherein obtaining the first mixture further comprises stirring the first mixture at a temperature in a range of 50° C. to 120° C.

18. The method of claim 10, wherein the heat-treating is performed in a reaction vessel containing 1 to 10 vol % of hydrogen gas based on a total volume thereof.

19. The method of claim 10, wherein the heat-treating is performed for 1 to 5 hours at the heat treatment temperature.

20. An electrode for a fuel cell comprising the catalyst of claim 1.
